(19) United States
(12) Patent Application Publication
(10) Pub. No.: US 2004/0189796 A1
(43) Pub. Date: Sep. 30, 2004

(54) Apparatus and method for converting two-dimensional image to three-dimensional stereoscopic image in real time using motion parallax

(75) Inventors: Choi Chul Ho, Kyunggi-do (KR); Kwon Byong Heon, Seoul (KR); Seo Burm Suk, Seoul (KR)

Correspondence Address: Timothy E. Newholm, BOYLE, FREDRICKSON, NEWHOLM, STEIN & GRATZ, S.C., 250 Plaza, Suite 1030, 250 East Wisconsin Avenue, Milwaukee, WI, 53202, US

(73) Assignee: FlatDis Co., Ltd.

(21) Appl. No.: 10/807,927

(22) Filed: Mar. 24, 2004

(30) Foreign Application Priority Data
Mar. 28, 2003 (KR) 10-2003-0019566

(51) Int. Cl. H04N 13/00

(52) U.S. Cl. 348/51; 348/42

(57) ABSTRACT

Disclosed is a current sample image acquisition unit for acquiring a current sample image, obtained by sampling a current input image provided by an image source; a previous sample image acquisition unit for acquiring a previous sample image, obtained by sampling a previous input image provided by the image source; a motion detector for detecting a moving pixel and a still pixel through comparison between corresponding pixels within the current and previous sample images; a region splitting unit for splitting the current sample image into a plurality of search regions and generating a representative value of the moving pixel in each search region using information about the moving pixel detected by the motion detector; a depth map generator for determining a moving pixel group constructing an object moving in each search region using the representative value of each search region and setting a small weight value for the moving pixel group, to generate a depth map image having the resolution of the original input image; and a positive parallax processor for generating a left-eye image and a right-eye image such that the depth map image is displayed on the display in such a manner that the moving pixel group is located before the screen of the display and remaining pixel groups are arranged behind the screen.

### BACKGROUND OF THE INVENTION

1. Field of the Invention

The present invention relates to an apparatus and method for generating a three-dimensional stereoscopic image. More particularly, the invention relates to a stereoscopic image conversion apparatus and method which generates a stereoscopic image having different perspective depths from a general two-dimensional image using motion parallax and provides a three-dimensional effect irrespective of the moving direction and speed of a moving object in the two-dimensional image.

2. Background of the Related Art

When a person sees an object, he/she accepts different images of the object through his/her left and right eyes, which is called binocular disparity. These two different images are made into one stereoscopic image in his/her brain, as shown in FIG. 1. When a person views a two-dimensional image, he/she is uncomfortable because the left and right eyes see the same image, differently from the case where the person sees a three-dimensional stereoscopic image. However, the person accepts it as a plane according to his/her experience accumulated up to now. Accordingly, in order to obtain a realistic cubic effect, a three-dimensional image is formed using a stereoscopic camera from the beginning, a two-dimensional image is converted to a three-dimensional image through a manual work, or rendering should be carried out twice for both eyes in the case of computer graphic. However, these works require lots of cost and time and cannot convert a vast amount of produced video data based on the existing two-dimension to three-dimensional images.

In the meantime, stereoscopic image conversion is to convert a still image or a moving image photographed by a monocamera using a conversion technique to produce a stereoscopic image. That is, the stereoscopic image conversion is a new technology that converts existing still images and two-dimensional images transmitted in real time and stored through a television, VCR, CD, DVD and so on to stereoscopic images without passing through a process of acquiring stereoscopic images. The stereoscopic image conversion technique requires a relatively complicated image processing and analysis technique.

The stereoscopic image conversion has attracted people's attention since early in the 1990s and has been gradually developed along with the development of video processing hardware and software. However, commercial application products to which the stereoscopic image conversion technique is applied have never been put on the market because it requires complicated hardware and there is a technical difficulty in development of software. In practice, the image conversion technique has very wide applications. For example, it can be applied to analog systems including a TV, a cable TV and a VCR, digital systems including a CD, a DVD and a digital TV, and various video formats such as Internet streaming video and AVI, Divx and so on.

The stereoscopic image conversion technique has become generally known to the public and products that embody the technique have come into the market since Sanyo Electronics Co., Ltd. developed a 2D/3D conversion TV for commercial purpose in 1993 first in the world. T. Okino group developed a commercial 2D/3D moving picture conversion TV using a Modified Time Difference (MTD) first in the world. The MTD is disclosed in an article entitled “New Television with 2D/3D Image Conversion Technologies” by T. Okino et al. in SPIE Photonic West, vol. 2653, pp. 96-103 and an article entitled “Conversion of Two-Dimensional Image to Three Dimensions” by H. Murata et al. in SID'95 DIGEST, pp. 859-862 in 1995.

The MTD is described with reference to FIG. 2. When an object, for example, a flying object, is moving to the right and a camera is at a standstill, if a stereoscopic image is constructed using a current Nth image as a left image and using a (N-1)th image among delayed images as a right image and then the stereoscopic image is displayed on a monitor to a viewer's left and right eyes, the flying object is viewed as if it is projected from the monitor toward the viewer and the background is displayed on the monitor so that the viewer can feel a three-dimensional cubic effect.

However, this technique provides a satisfactory cubic effect only when the object is moving horizontally at relatively low speed, as shown in FIG. 2. If the left and right images are changed with each other, the object is perceived as if it is located behind the background. This is contrary to the human three-dimensional perception so that the viewer feels eyestrain. Furthermore, when the object is not moving horizontally, the moving object is viewed as a double image so that the cubic effect cannot be obtained. Moreover, the left or right image should be selected from delayed images according to the speed of the moving object. That is, the image right before a current image should be selected when the object is moving fast but the second through fifth delayed images from the current image should be selected when the object is moving slowly. However, there is a limitation in selecting a delayed image having sufficient binocular disparity that can provide the cubic effect even in the image having a fast moving object. In addition, there is a limitation in storing more than the third delayed image in view of hardware complexity in the case of the image having a slowly moving object.

There has been proposed a stereoscopic image conversion technique that produces stereo images using depth information of an image. This technique is disclosed in an article entitled “Conversion System of Monocular Image Sequence to Stereo using Motion Parallax” by Y. Matsumoto et al. in SPIE Photonic West, vol. 3012, pp. 108-115 in 1997.

The technique proposed by Matsumoto et al., which produces a stereo image using depth information of an image, was employed in the commercial product of Sanyo Electronics Co., Ltd. In the case of a slowly moving image, the motion of the image is extracted and depth values of a current image block are extracted using a motion based depth decision algorithm, to produce left and right images through perspective projection used in computer graphics. This technique has a shortcoming that an image distortion is generated because of the perspective projection to deteriorate picture quality. Thus, this technique can obtain a cubic effect when applied to the case where the motion of a camera and an object are not large rather than the case of a fast moving object.

The stereoscopic image conversion technique of TransVision uses relative motion of pixels between a camera and the image of an object. This technique is based on spatial-temporal interpolation that is human visual characteristic, proposed by Garcia (referring to an article entitled “Approaches to Stereoscopic Video Based on Spatio-Temporal Interpolation” by B. J. Garcia in SPIE Photonic West, vol. 2635, pp. 85-95, San Jose, 1990). The Transvision Stereoscopic image conversion technique obtains depth information using a variation in the motion of pixels between images, determines an image to be displayed to left and right eyes and a maximum parallax value using the depth information, and then selects delayed images. When a moving image generated in this manner is stored in a VCR, a stereoscopic image can be displayed on a TV screen when the VCR is directly connected to the TV set. Furthermore, a two-dimensional moving image can be seen as a stereoscopic image on the TV screen by connecting a DSP board to medical implements or TV sets. Although this technique provides a satisfactory cubic effect in the case of a slowly moving image, a ghost appears in a fast moving image.

The aforementioned conventional stereoscopic image conversion techniques require analysis of the moving direction and moving speed of an object in an image, that is, accurate image analysis such as high-speed/low-speed horizontal motion, non-horizontal motion, high-speed motion, scene change, zoom image and so on, and they need appropriate processing techniques suitable for the image analysis.

### SUMMARY OF THE INVENTION

Accordingly, an object of the present invention has been made in view of the above-mentioned problems occurring in the prior art, and it is to provide an apparatus and method for converting a two-dimensional image to a stereoscopic image, which extracts motion parallax from a two-dimensional moving image to generate a stereoscopic image having different perspective depths and provides a three-dimensional cubic effect irrespective of the moving direction and speed of a moving object in the two-dimensional image.

Another object of the present invention is to provide an apparatus and method for converting a two-dimensional image to a three-dimensional image, which provides a stereoscopic image having different perspective depths in real time using motion parallax in the two-dimensional image irrespective of the moving direction and speed of a moving object in the two-dimensional image.

To achieve the objects, according to the present invention, there is provided an apparatus for converting a two-dimensional image to a three-dimensional stereoscopic image to display the converted stereoscopic image on a display, including: a current sample image acquisition unit for acquiring a current sample image, obtained by sampling a current input image provided by an image source; a previous sample image acquisition unit for acquiring a previous sample image, obtained by sampling a previous input image provided by the image source; a motion detector for detecting a moving pixel and a still pixel through comparison between corresponding pixels within the current and previous sample images; a region splitting unit for splitting the current sample image into a plurality of search regions and generating a representative value of the moving pixel in each search region using information about the moving pixel detected by the motion detector; a depth map generator for determining a moving pixel group constructing an object moving in each search region using the representative value of each search region and setting a small weight value for the moving pixel group, to generate a depth map image having the resolution of the original input image; and a positive parallax processor for generating a left-eye image and a right-eye image such that the depth map image is displayed on the display in such a manner that the moving pixel group is located before the screen of the display and remaining pixel groups are arranged behind the screen. According to the present invention, the motion detector detects the moving pixel by obtaining an absolute value of a difference between the corresponding pixels within the current and previous sample images and comparing the absolute value with a predetermined threshold value. According to the present invention, the depth map generator determines pixels having errors in a predetermined range based on the representative value as the moving pixel group constructing the moving object.

According to the present invention, the predetermined range is upper 25% and lower 25% relative to the representative value.

According to the present invention, the depth map generator sets a relatively large weight value for the remaining pixel groups other than the moving pixel group.

According to the present invention, the weight value is a depth value.

According to the present invention, the apparatus further includes a masking processor that removes an impulse noise from the depth map image generated by the depth map generator to provide it to the positive parallax processor.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows the principle of stereoscopic vision;

FIG. 2 shows the principle of a conventional MTD (Modified Time Difference) technique;

FIG. 3 shows the principle of convergence and binocular disparity;

FIG. 4 is a graph showing the relationship between a depth sensitivity and an observation distance in visual factors causing depths;

FIG. 5 is a block diagram of a stereoscopic image conversion apparatus according to a present invention;

FIG. 6 is a diagram for explaining the operation of the sample image acquisition unit shown in FIG. 5;

FIG. 7 is a diagram for explaining the operation of the region splitting unit shown in FIG. 5;

FIG. 8 is a diagram for explaining the operation of the filter shown in FIG. 5;

FIG. 9 is a diagram for explaining a screen surround problem generated in the positive parallax processor shown in FIG. 5;

FIGS. 10a and 10b are diagram for explaining positive parallax processing and negative parallax processing carried out by the positive parallax processor shown in FIG. 5;

FIG. 11 is a diagram for explaining the operation of the interpolator shown in FIG. 5;

FIGS. 12a and 12b show (N-1)th and Nth frames of a garden image used for judging the performance of the stereoscopic image conversion apparatus according to the present invention;

FIGS. 13a and 13b show (N-1)th and Nth frames of an image of playing a table tennis, used for judging the performance of the stereoscopic image conversion apparatus according to the present invention,

FIGS. 14a and 14b explain depth differences judged by applying the conventional MTD technique and the method of the present invention to the images shown in FIGS. 12a and 12b; and

FIGS. 15a and 15b explain depth differences judged by applying the conventional MTD technique and the method of the present invention to the images shown in FIGS. 13a and 13b.

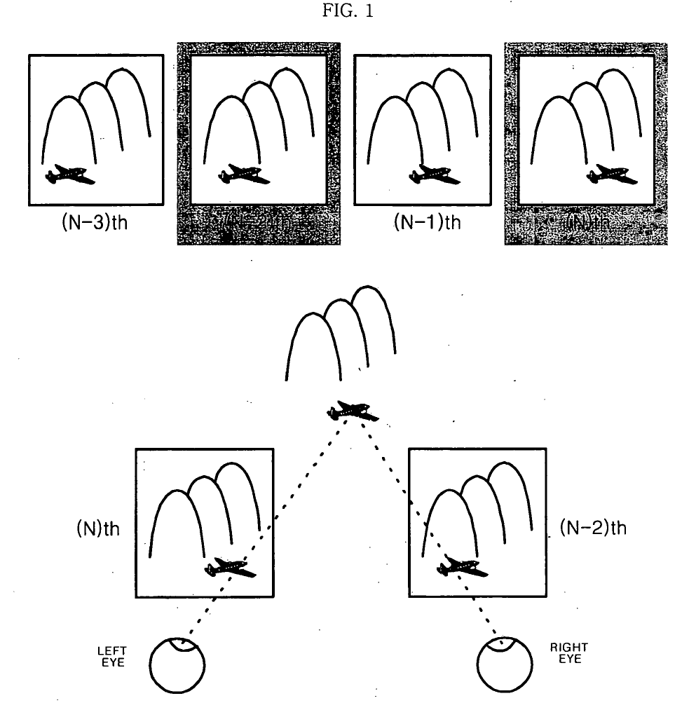

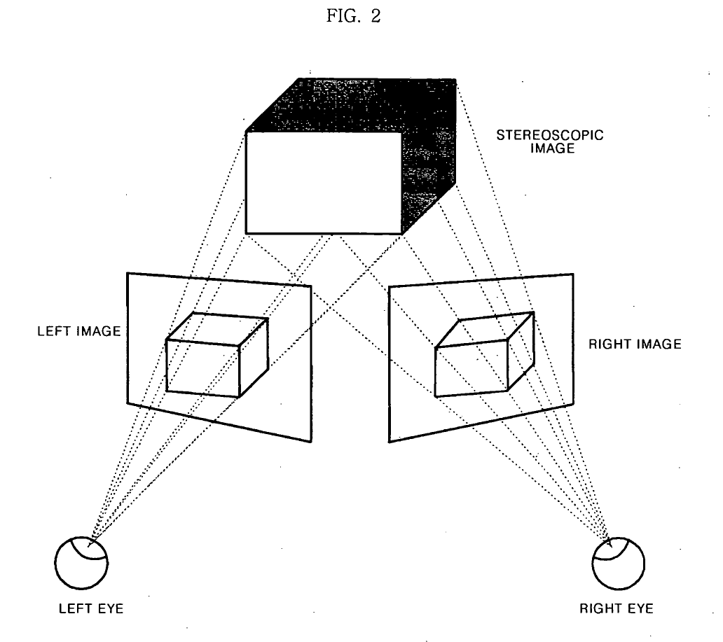

### DETAILED DESCRIPTION OF THE INVENTION

Reference will now be made in detail to the preferred embodiments of the present invention, examples of which are illustrated in the accompanying drawings.

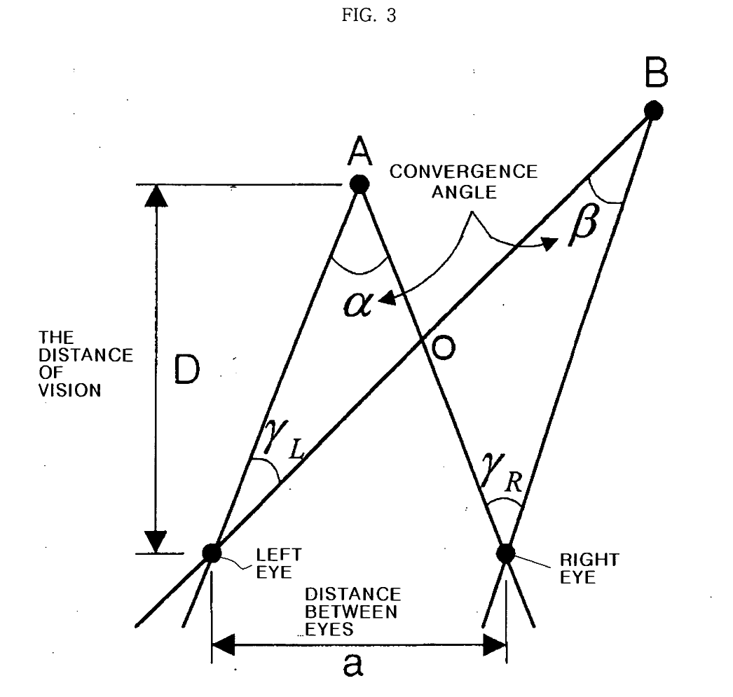

A preferred embodiment of the present invention is described with reference to FIGS. 3 through 14.

First of all, various factors related with depth perception are explained before description of the present invention.

Various cues are used when we perceive a space with depths stereoscopically. Three-dimensional viewing, in general, relies upon two fundamental classes of depth perception cues: binocular cues and monocular cues, which are shown in the following table.

TABLE 1

| Binocular cues | Monocular cues |
|---|---|
| Convergence | Focus adjustment |
| Binocular disparity | Motion parallax |
| | Range of vision |
| | Aerial perspective |
| | Linear perspective |
| | Texture gradient |
| | Shadow |
| | Interposition |

The binocular cues are explained first with reference to FIG. 3. The binocular cues according to the fact that a human being has two eyes, whose pupils are, on average, 6.5 cm apart horizontally are especially important in depth perception. The binocular cues include convergence and binocular disparity.

As shown in FIG. 3, when a person sees a certain object A, his/her eyes rotate inward to focus upon the object, which is referred to as “convergence”. The angle ‘α’ formed by the two eyes as they focus upon the object A is called convergence angle. Depth sensitivity according to convergence is effective in the case of short distances of up to 20 cm. However, convergence is ineffective in the case of long distances because the convergence angle is decreased as distances become longer.

Binocular disparity refers to the condition where when one stares at an object, there is a slight inconsistency between the images projected onto the left and right retinas due to different sight angles for the left and right eyes. Referring to FIG. 3, when one stares at the object A, a difference between the object A and an object B that is located apart from the object A and has a depth different from that of the object A, that is, an angle of (γ_{L}-γ_{R}) or (β-α) is the binocular disparity. With a small binocular disparity, two retina images together give a three-dimensional image so that definite depths are perceived depending on the distance between the two eyes and direction of the eyes. This effect is frequently used in a general stereoscopic display.

The monocular cues include motion parallax, focus control, range of vision, aerial perspective, linear perspective, texture gradient, shadow and interposition, as shown in Table 1. Depth perception according to the monocular cues is made by changing the thickness of the lens of eye to adjust the focus. This is effective only when an observation distance is as short as 2-3 m. For example, when a scene is viewed through the window of a running train, objects closer to the observer, such as houses and roadside trees, travel at faster speed and in the direction opposite to that of the train while distant objects such as mountains or clouds are viewed as if they are stationary. Furthermore, when the observer moves his/her head while staring at a certain object, objects apart from a fixation point are seed as if they are moved in the same direction as the moving direction of the observer and objects positioned before the fixation point are viewed as if they are largely moved in the opposite direction. Image change due to motion of the observer is called motion parallax. The effect of depth judgement according to the motion parallax is effective as much as the binocular disparity according to conditions, and the motion parallax currently serves as an effective cue to give depths to two-dimensional images.

In the meantime, when there is a limitation in a range in which an object can be observed, the observer receives a restricted impression different from usual experiences. The wider the range, the stronger presence. The range of vision is effective to raise depth sensitivity and used in a large-scale movie or highvision. In the case of a known object, as it looks smaller, it is felt as if it is located in longer distance. That is, depth cues can be obtained depending on the size of a retina image.

In addition, aerial perspective refers to the condition that distant objects become tinged with a blue color due to impurities in the atmosphere. Linear perspective is convergence of lines as they recede into the distance. Texture gradient is the condition that the texture within a scene becomes more finely grained with distance. Furthermore, shadow and interposition referring to partial covering of one object by another are important cues.

FIG. 4 is a graph showing the relationship between depth sensitivity and observation distance in each of the cues. When a distance to an object is D and the minimum distance variation capable of perceiving a change in the depth of the object when the object is moved backward is ΔD, depth sensitivity is defined by Equation 1.

$$Depth sensitivity = \frac{D}{Δ D} \qquad [ Equation 1 ]$$

That is, the smaller the distance variation ΔD, the higher the depth sensitivity at the certain distance of vision D. Effective ranges of convergence, binocular disparity, motion parallax, size of retina image, aerial perspective, texture and brightness among the aforementioned cues are shown in FIG. 4 using the depth sensitivity.

It can be known from FIG. 4 that binocular disparity is very important in a distance within 10 m, motion parallax is effective in the case of optimum moving speed and, especially, it is more effective than binocular disparity in a long distance. Furthermore, it can be also known that retina image size and aerial perspective are important in the case of an object positioned in a very long distance.

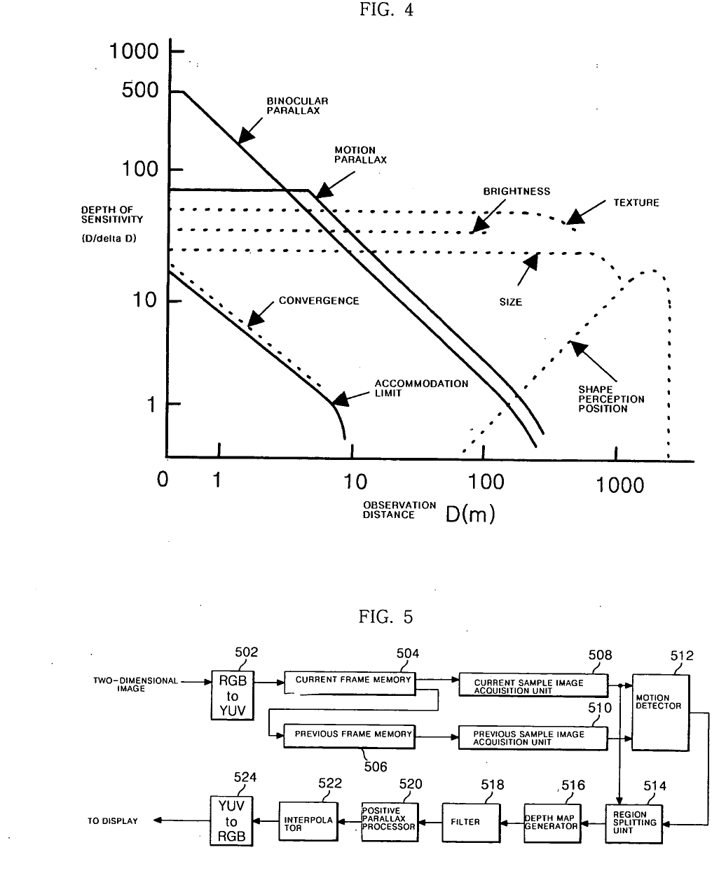

FIG. 5 is a block diagram of an apparatus for converting a two-dimensional image to a three-dimensional image according to a preferred embodiment of the present invention. Referring to FIG. 5, the image conversion apparatus includes an RGB-YUV converter 502 for converting a two-dimensional RGB color image provided by an image source (not shown) to a YUV image, a current frame memory 504, a previous frame memory 506, a current sample image acquisition unit 508, a previous sample image acquisition 510, a motion detector 512, a region splitting unit 514, a depth map generator 516, a filter 518, a positive parallax processor 520, an interpolator 522 and a YUV-RGB converter 524 for converting a YUV image to an RGB color image.

The current frame memory 504 and previous frame memory 506 store a current YUV image and a previous YUV image converted by the RGB-YUV converter 502, respectively.

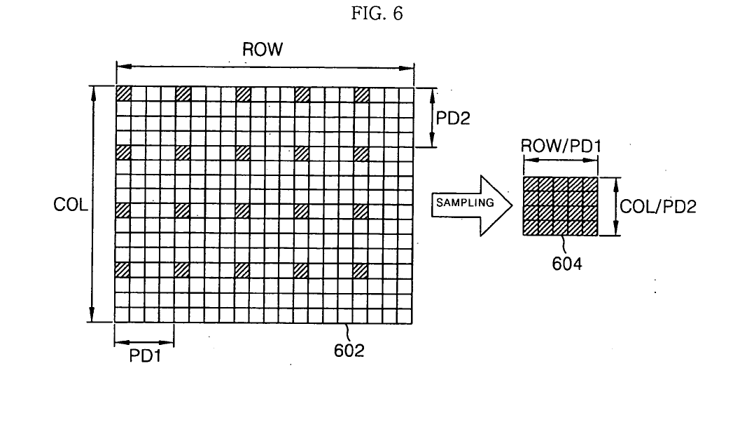

The current sample image acquisition unit 508 and previous sample image acquisition unit 510 respectively acquire sample images having a size of PD1×PD2 and resolution lower than current and previous YUV images converted by the RGB-YUV converter 502 for efficient calculation and real-time processing of motion parallax. FIG. 6 shows a procedure of acquiring the sample images using the current and previous sample image acquisition units 508 and 510. Referring to FIG. 6, the current sample image acquisition unit 508 samples the current YUV image, which is stored in the current frame memory 504, at an equal interval, to obtain a sample image 604 having a width of PD1 and a length of PD2. The previous sample image acquisition unit 510 samples the previous YUV image, stored in the previous frame memory 506, at an equal interval, to obtain a sample image 604 having a width of PD1 and a length of PD2. In FIG. 6, ROW represents the number of horizontal pixels of an input image 602 and PD1 indicates the number of horizontal pixels of the sample image 604. In addition, COL represents the number of vertical pixels of the input image 602 and PD2 means the number of vertical pixels of the sample image 604. Here, the sample image 604, acquired by each of the current and previous sample image acquisition units 508 and 510, has the same shape information and luminance distribution characteristic as those of the original input image 602. That is, there is no problem in utilization of the sample image 604 to calculate motion parallax in real time because the average and standard deviation of histogram with respect to the sample image 604 are identical to those of the original input image 602.

The motion detector 512 detects pixels in motion from luminance signals of the current and previous sample images 604 acquired by the current and previous sample image acquisition units 508 and 510. This is carried out through the following equations.

[Equation 2]

Dₚᵢₓₑₗ=ABS(P_{(N)th})−(P_{(N-1)th})

[Equation 4]

If (Dₚᵢₓₑₗ>Dₜₕ), then

where P_{(N)th} is a moving pixel, else P_{(N)th} is a still pixel.

Specifically, an absolute value DPₚᵢₓₑₗ of a difference between pixels of the current sample image P_{(N)th} acquired by the current sample image acquisition unit 508 and pixels of the previous sample image P_{(N-1)th} obtained by the previous sample image acquisition unit 510 is calculated and compared with a threshold value Dₜₕ to discriminate still pixels from moving pixels. In the present invention, the pixels in the current and previous sample images are detected as only two types of still and moving pixels. In general, still pixels construct a background and are considered to be located in relatively long distance, and moving pixels are considered to be placed in relatively short distance. Information about the still pixels and moving pixels detected by the motion detector 512 is provided to the region splitting unit 514 together with the current sample image 604 acquired by the current sample image acquisition unit 508.

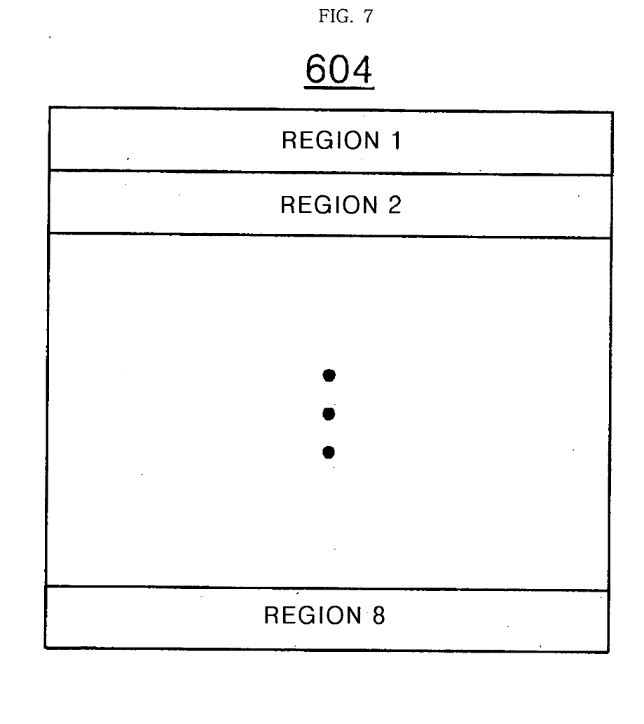

The region splitting unit 514 splits the current sample image into search regions using pixel values constructing a background or a moving object in the sample image. Referring to FIG. 7, the region splitting unit 514 divides the sample image 604 into eight search regions and calculates a representative value Pₜₕ of still pixel values or moving pixel values in each search region. In the present invention, the sample image is divided into eight in order to reduce a detection error generated when a moving pixel value is composed of different gray scale values not the same gray scale over the entire image. When it is assumed that there is an image in which a person is running on a playground, for instance, the background is the playground and the moving object is the running person. Here, the head, face, upper and lower bodies of the person have different gray scales. Thus, the image should be split into multiple search regions in order to detect the overall area of the person.

The depth map generator 516 generates a depth map having the resolution of the original input image as represented by the following equation using the eight representative values of the moving pixels, calculated in the eight search regions by the region splitting unit 514.

[Equation 4]

if (0.75×Pₜₕ<P_{(N)th}<1.25×Pₜₕ), then

Depth_{(N)} is small, else Depth_{(N)th} is large.

Specifically, the depth map generator 516 determines pixel values having errors of upper 25% and lower 25% relative to the representative value P_{(N)th} of the moving pixels as a moving pixel group constructing the moving object according to experimental results. Since the moving pixel group is a region placed in relatively short distance compared to the background, its weight value, that is, depth value, is set to a small value. The depth value of a background pixel group constructing the background is set to a large value.

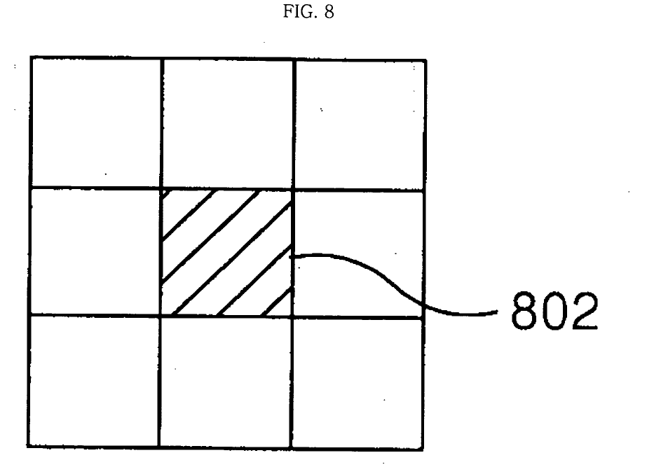

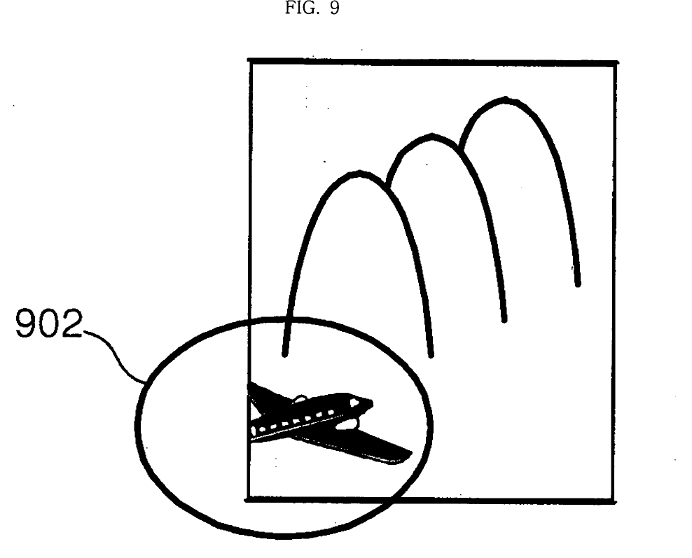

The filter 518 removes an impulse noise from the depth map generated by the depth map generator 516 to perform masking process for the depth map in order to generate a more natural stereoscopic image. The noise filtering process is explained in detail with reference to FIG. 8. As shown in FIG. 8, when depth information of a certain pixel 802 whose noise will be removed is different from depth information of eight pixels surrounding the pixel 802, the depth information of the pixel 802 is assumed to be a noise and set to be identical to the depth information of the surrounding pixels. The depth map of the original image, filtered by the filter 518, is provided to the positive parallax processor 520.

The positive parallax processor 520 carries out positive parallax process for the background and moving object in the depth map of the original image, masked by the filter 518, to generate left-eye and right-eye images. If negative parallax process is executed for the background and moving object in order to make the moving object be viewed as if it is placed before the screen, it violates interposition of the aforementioned monocular cue. Thus, natural cubic effect cannot be provided. This phenomenon is called screen surround. For instance, when we watch a stereoscopic image through a TV receiver or a monitor, as shown in FIG. 9, sometimes we cannot see the entire shape of an object 902 (an airplane, for example) because the object is located at the edge of the screen. Accordingly, the present invention performs positive parallax process in order to solve the problem caused by the negative parallax.

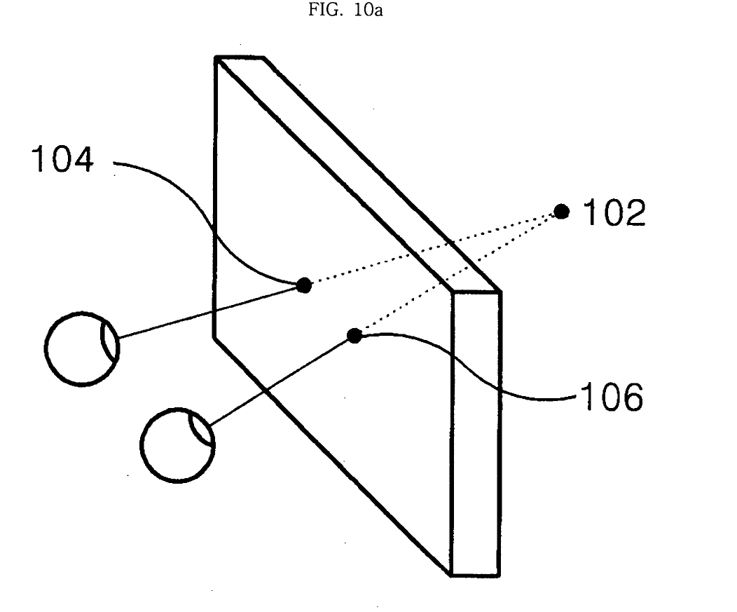

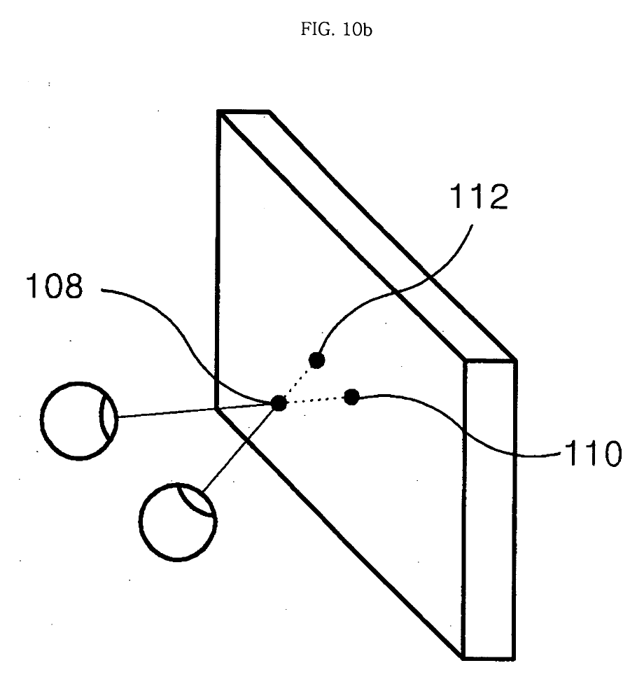

The positive parallax corresponds to the case where a person sees an object located in a very long distance, as shown in FIG. 10a. That is, the lines of vision from both eyes to fixation point 102 on the screen are parallel with each other. Thus, when left and right points 104 and 106 on the screen are alternately shown to the left and right eyes, the two points 104 and 106 are merged into one so that it is viewed as if it is located behind the screen. The negative parallax is opposite to the positive parallax and corresponds to the case where the lines of vision from both eyes to a fixation point 108 on the screen cross each other, as shown in FIG. 10b. Thus, when left and right points 110 and 112 on the screen are alternately shown to the left and right eyes, the two points 110 and 112 are merged into one so that it is viewed as if it is located before the screen.

Accordingly, the positive parallax processor 520 of the present invention generates a left-eye image by shifting all of pixels of the background and moving object in the depth map of the original image by two pixels to the left and creates a right-eye image by shifting all of the pixels by two pixels to the right. A composite image of the left-eye and right-eye images processed by the positive parallax processor is viewed as if it is located inside the screen when displayed on a display such as a TV receiver or a monitor. Then, the positive parallax processor shifts pixels corresponding to a moving object in the left-eye image by three pixels to the left and shifts pixels corresponding to a moving object in the right-eye image by three pixels to the right on the basis of the perspective depth map because the moving object has a depth difference smaller than that of the background. Consequently, the moving object displayed on a display is viewed as if it is located inside the screen and the background is seen as if it is placed behind the moving object.

In the meantime, a person sees an object according to two mechanisms of accommodation and convergence, which occur simultaneously. Accommodation refers to the ability of the ciliary muscles surrounding the lens of an eye to alter the thickness of the lens, thereby sharply focusing the light rays coming from an object. Convergence refers to inward rotation of the eyes when one stares at an object.

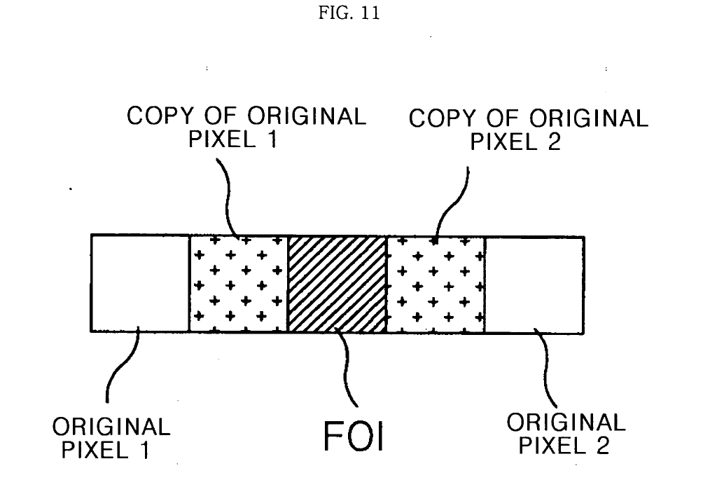

When the positive parallax processor 520 generates the left-eye and right-eye images through positive parallax processing in order to give depth to a stereoscopic image, a space corresponding to three pixels is generated at the boundary of the moving object and background. Large parallax separates accommodation from convergence to make a viewer feel uncomfortable. Accordingly, the interpolator 522 of the present invention limits a depth difference between the background and moving object to three pixels in order to solve the problem of separating accommodation and convergence from each other. Occlusion caused by a depth difference is solved by using an interpolation algorithm such as FOI (First Order Interpolation) or ZOI (Zero Order Interpolation). The interpolation algorithm is a method of interpolating a pixel between two adjacent pixels A and B. The FOI performs interpolation using an average value of the two pixels A and B, as shown in FIG. 11. The result of FOI is (A−(0.5×(A+B))−B). The ZOI duplicates the pixel A or pixel B. The result of ZOI is (A−A−B) or (A−B−B).

The YUV-RGB converter 524 converts a YUV image interpolated by the interpolator 522 to an RGB color image to provide it to a display (not shown), thereby displaying a three-dimensional stereoscopic image.

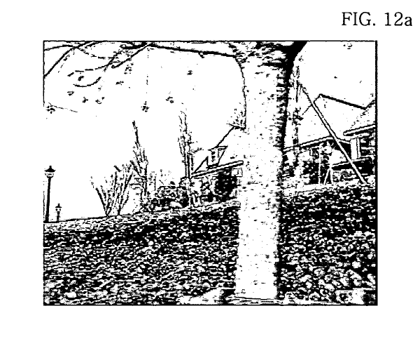

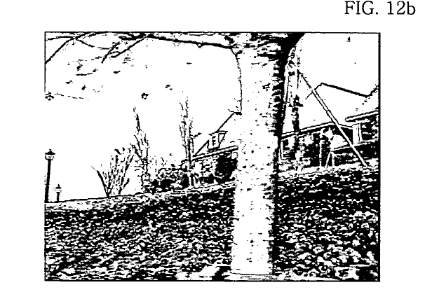

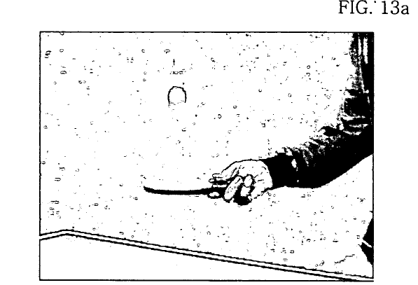

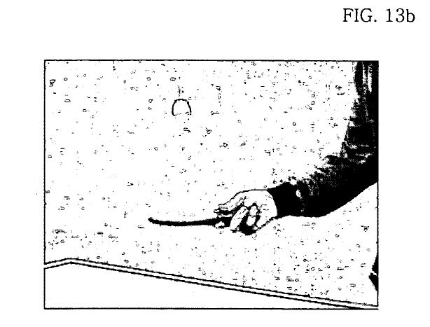

The results of experiments that were executed in order to judge the performance a stereoscopic image conversion method carried out by the stereoscopic image conversion apparatus of the present invention are described below. For the judgement, an image of ‘garden’ (referring to FIGS. 12a and 12b) and an image of ‘playing table tennis’ (referring to FIGS. 13a and 13b) were used. In addition, the performance of the stereoscopic image conversion of the present invention was compared to the performance of the MTD technique that is a conventional representative stereoscopic image conversion method through a computer simulation. To effectively judge the performance of the method of the present invention and the conventional MTD technique, an absolute value (hereinafter, referred to as “a depth difference image”) of a difference between pixels of left and right images generated by each of the two methods was obtained to judge whether or not the two methods appropriately applied depths to a background and a moving object. That is, the contour of a moving object in the depth difference image was detected using the following equation to compare depth processing effects of the background and moving object in the method of the present invention and the conventional MTD.

[Equation 5]

P_{SIM}=ABS(P_{LEFT}−P_{RIGHT})

In Equation 5, P_{LEFT} represents the pixel of the left image and P_{RIGHT} represents the pixel of the right image. P_{SIM} means the absolute value of the difference between the pixels of the left and right images.

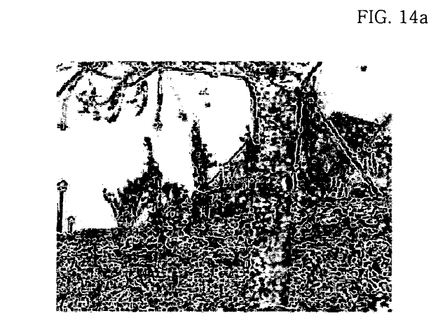

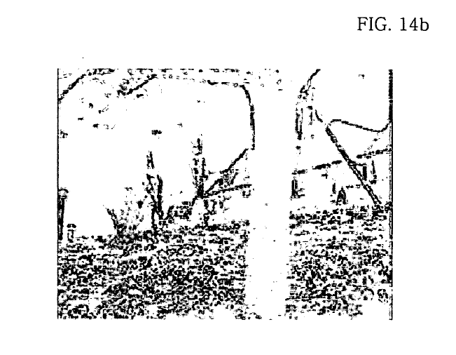

The image of ‘garden’ shown in FIGS. 12a and 12b has trees and a garden that are simply moving from left to right and a background. In this case, both the method of the present invention and the conventional MTD technique have a similar depth difference, as shown in FIGS. 14a and 14b.

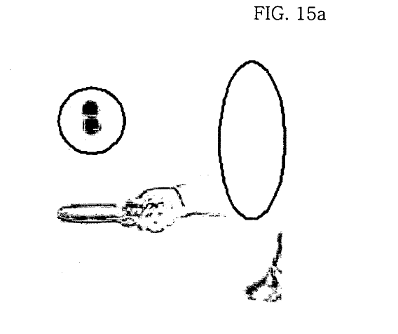

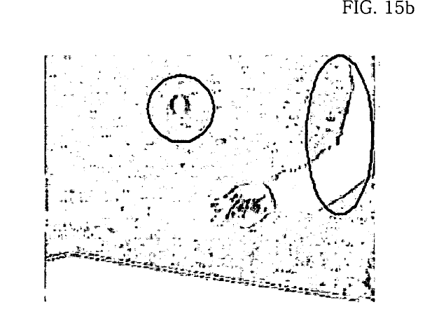

In contrast to the ‘garden’ image, the image of ‘playing table tennis’ shown in FIGS. 13a and 13b has a vertically moving object (that is, a ping-pong ball). Referring to FIGS. 15a and 15b, it can be seen that the method of the present invention and the conventional method have different depth differences. In the case of the image according to the conventional MTD technique, it is viewed as if there are two ping-pong balls (referring to the circled portion). In the image generated by the image conversion method of the present invention, one ping-pong ball is viewed. In addition, the left arm of a player (referring to the circled portion) is not definite in the image obtained by the conventional MTD technique while it is clear in the image generated by the method of the present invention. Accordingly, when a viewer watches the image converted through the MTD technique, the ping-pong ball is viewed as double image and only the player's wrist and racket are stereoscopically seen. That is, the MTD makes the viewer feel uncomfortable and increases eyestrain. On the other hand, the method of the present invention generates the image in which the player's right arm as well as the player's wrist and racket are clearly seen and the ping-pong ball is viewed as one. That is, the present invention provides a natural cubic effect.

In the case where stereoscopic image conversion is carried out using the MTD technique, not only the moving direction of a moving object in an image but its moving speed must be considered. That is, since depth generated by the MTD technique sensitively depends on the speed of the moving object, at least three frame memories and a complicated control technique are needed in order to obtain a natural cubic effect. However, the stereoscopic image conversion according to the present invention can provide a natural cubic effect using motion detection, region division and two frame memories irrespective of the moving speed and direction of the moving image in an image.

Accordingly, the present invention can separate a moving image and a background in a general two-dimensional image from each other through motion detection and region division irrespective of the moving direction and speed of the moving image so as to provide a natural cubic effect.

Furthermore, the present invention is suitable for converting a high-resolution image to a stereoscopic image in real time and can be applied to various video formats including TV, cable TV, VCR, CD, DVD, AVI, DIVX and so on in real time.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for converting a two-dimensional image to a three-dimensional stereoscopic image to display the converted stereoscopic image on a display, comprising:
a current sample image acquisition unit for acquiring a current sample image, obtained by sampling a current input image provided by an image source;
a previous sample image acquisition unit for acquiring a previous sample image, obtained by sampling a previous input image provided by the image source;
a motion detector for detecting a moving pixel and a still pixel through comparison between corresponding pixels within the current and previous sample images;
a region splitting unit for splitting the current sample image into a plurality of search regions and generating a representative value of the moving pixel in each search region using information about the moving pixel detected by the motion detector;
a depth map generator for determining a moving pixel group constructing an object moving in each search region using the representative value of each search region and setting a small weight value for the moving pixel group, to generate a depth map image having the resolution of the original input image; and
a positive parallax processor for generating a left-eye image and a right-eye image such that the depth map image is displayed on the display in such a manner that the moving pixel group is located before the screen of the display and remaining pixel groups are arranged behind the screen.

2. The apparatus as claimed in claim 1, wherein the motion detector detects the moving pixel by obtaining an absolute value of a difference between the corresponding pixels within the current and previous sample images and comparing the absolute value with a predetermined threshold value.

3. The apparatus as claimed in claim 1, wherein the representative value of the moving pixel, generated by the region splitting unit, is an average value or an intermediate value of moving pixels in each search region.

4. The apparatus as claimed in claim 3, wherein the depth map generator determines pixels having errors in a predetermined range based on the representative value as the moving pixel group constructing the moving object.

5. The apparatus as claimed in claim 4, wherein the predetermined range is upper 25% and lower 25% relative to the representative value.

6. The apparatus as claimed in claim 1, wherein the depth map generator sets a relatively large weight value for the other pixel groups except the moving pixel group.

7. The apparatus as claimed in claim 1, wherein the positive parallax processor generates the left-eye image by shifting all the pixel groups in the depth map image by a first number of predetermined pixels to the left and shifting the moving pixel group by a second number of predetermined pixels to the left, and creates the right-eye image by shifting all the pixel groups in the depth map of the original image by the first number of predetermined pixels to the right and shifting the moving pixel group by the second number of predetermined pixels to the right.

8. The apparatus as claimed in claim 1, further comprising an interpolator for interpolating a depth difference of the background and the moving object in the left-eye and right-eye images generated by the positive parallax processor.

9. The apparatus as claimed in claim 8, wherein the interpolator uses zero order interpolation (ZOI) and first order interpolation (FOI).
